(19) United States
(12) Patent Application Publication
(10) Pub. No.: US 2009/0210886 A1
(43) Pub. Date: Aug. 20, 2009

(54) Method and system for defining financial transaction notification preferences

(76) Inventors: Sandeep M. Bhojwani, San Jose, CA (US); Sudhir Bhojwani, San Jose, CA (US); David H. Martin, San Jose, CA (US)

Correspondence Address: SCHEIN & CAI LLP;James Cai, 111 W. ST. JOHN ST., SUITE 1250, SAN JOSE, CA, 95113, US

(21) Appl. No.: 12/070,706

(22) Filed: Feb. 19, 2008

(51) Int. Cl. G06F 9/44

(52) U.S. Cl. 719/318

(57) ABSTRACT

A method and system for defining financial transaction notification preferences is disclosed. A computer-implemented method for defining notification preferences using a financial transaction notification message served to a user on a mobile device and using properties of the financial transaction includes the steps of serving the financial transaction notification message, the financial transaction notification message being related to a financial transaction performed by the user, receiving a notification preference response message from the user, and defining at least one notification filtering rule based on the notification preference response message and the properties of the financial transaction. A system operable to implement the computer-implemented method includes a transaction notification module operable to serve the financial transaction notification message, the financial transaction notification message being related to a financial transaction performed by the user, a notification preference receiver module operable to receive a notification preference response message from the user, and a notification preference processor module operable to define at least one notification filtering rule based on the notification preference response message and the properties of the financial transaction.

### BACKGROUND OF THE INVENTION

1. Field of the Invention

The present invention generally relates to mobile banking services and more particularly to a method and system for defining financial transaction notification preferences.

2. Description of the Related Art

Financial institutions provide alert services to their account holders including alerts served via an email or an SMS message when a condition matching user selected notification criteria occurs relating to the user's financial account. Examples of user selected notification criteria include a maximum spending limit having been reached, a transaction greater than a certain amount having been recorded on the account, and the approach of a payment due date. The alerts allow a user to track key account conditions.

Some financial institutions provide their customers with per transaction notification alerts (hereinafter referred to as financial transaction notification messages) on their mobile devices in order to reduce fraud by allowing the customer to be aware of transactions as they happen. Users may customize the service by setting transaction notification criteria including delivery preferences such as when and how the financial transaction notification messages are served to the user. For example, the user may specify that financial transaction notification messages be served only between 7 P.M. and 9 P.M. and that the messages be served as SMS messages.

In addition to delivery preferences, financial institutions support monetary limit based notification preferences that allows a user to restrict delivery of financial transaction notification messages to transactions that exceed a certain transaction amount. This criterion allows the user to receive notification of major transactions and to avoid notifications of smaller transactions. This criterion also provides a means of managing notifications as the volume of transactions performed by the user may be great and the user may find it undesirable to receive a notification for every transaction performed. However, by restricting delivery of notifications to transactions that exceed the monetary limit, transactions of interest to the user may be excluded.

Existing systems are limited to providing users with the ability to select only delivery preferences and monetary limit based notification preferences. As such, these systems do not provide a means by which properties of a financial transaction including the location of the transaction, the type of merchant where the transaction was performed, the type of transaction, and the merchant name can be used to define notification preferences. Nor do existing systems provide a means by which such properties can be combined to define notification preferences.

In view of the above, there remains a need in the art for a method and system for defining financial transaction notification preferences that overcome the limitations of the prior art. The method and system preferably provide a means by which a user may define notification preferences based on properties of a financial transaction performed by the user. The method and system also preferably provide an interactive means by which the user may define notification preferences. The method and system further preferably provide a means by which a financial transaction notification message provides a context for the user to define notification preferences.

### SUMMARY OF THE INVENTION

The method and system for defining financial transaction notification preferences in accordance with the invention provide a means by which a user defines notification preferences in response to receipt of a financial transaction notification message. The financial transaction notification message is served to a user's mobile device and includes properties of a financial transaction performed by the user. The properties of the financial transaction provide a context for the user to define notification preferences. Such properties may include a transaction location including an address of a merchant or card acceptor where the transaction occurred, a merchant name, a merchant zip code, a transaction type, a merchant type, a transaction amount, and the date and time of the transaction.

The financial transaction notification message may include an action code or other means by which the user defines the notification preference. The action code in a notification preference response message sent by the user in response to the financial transaction notification message is processed to define a notification filtering rule. Subsequent financial transaction notification messages served to the user following a subsequent financial transaction are filtered in accordance with the notification filtering rule and other notification filtering rules previously defined.

Notification preferences may correspond to properties of the financial transaction. A first notification preference may correspond to the merchant name where the financial transaction was performed and may serve to indicate a user preference to not receive financial transaction notification messages related to financial transactions performed by the user with the named merchant. A second notification preference may correspond to the location where the financial transaction was performed and may serve to indicate a user preference to not receive financial transaction notification messages related to financial transactions performed by the user at the location. Notification filtering rules are defined based on notification preferences and corresponding properties of the financial transaction.

Notification filtering rules include filtering criteria that reflect a user's notification preferences and are used by a transaction notification and notification preference (TNNP) system operable to send financial transaction notification messages to the user. The TNNP system uses the notification filtering rules to determine if a financial transaction notification message relating to a financial transaction performed by the user is served to the user. The TNNP system applies the notification filtering rules to the properties of the financial transaction in making this determination.

Notification filtering rules may include an expiration date and time that defines the time at which the notification filtering rule expires. The expiration date and time may be provided in the notification preference response message as a user preference. Alternatively, the expiration date and time may be system dependant.

Notification filtering rules may also include a rule counter that causes the rule to expire after a specified number of times in which the filtering criteria for the rule are met. The value of the rule counter may be provided in the notification preference response message as a user preference. Alternatively, the value of the rule counter may be system dependent.

The method and system in accordance with the invention allow the user to interactively set notification preferences in the notification preference response message by responding to financial transaction notification messages. Each time the user receives a financial transaction notification message related to a financial transaction performed by the user, the user may be provided an opportunity to set a notification preference related to the financial transaction by responding to the financial transaction notification message with a notification preference. The user is thus enabled to set the notification preference related to the financial transaction following performance of the financial transaction.

Notification preferences the user can define by responding to the financial transaction notification message include preferences for excluding further financial transaction notification messages related to the location where the transaction was performed, the merchant involved in the transaction, the transaction type, the merchant type, and the transaction amount. Additionally, combinations of these preferences may be combined such as excluding financial transaction notification messages related to financial transactions of less than a selected amount at a selected merchant.

Users can set notification preferences based on options provided in the financial transaction notification message. In accordance with one embodiment of the invention, the financial transaction notification message includes at least one action code corresponding to a notification preference related to a property of the financial transaction. The notification preference response message may include the at least one action code.

Alternatively, the notification preference response message may explicitly include the properties required to create the notification filtering rule related to the notification preference.

The financial transaction notification message may be served using messaging protocols including SMS, WAP Push, MMS, XMPP, USSD, Email, and other messaging protocols supported by the user's mobile device. The notification preference response messages may be sent using messaging protocols including SMS, MMS, WAP Push, Email, USSD, XMPP, SOAP, and HTTP.

In accordance with one embodiment of the invention, the user receives a financial transaction notification message as an SMS message and the SMS message includes at least one action code corresponding to a notification preference. The user defines a notification preference by sending a response SMS message including the at least one action code in the body of the response SMS message.

In accordance with another embodiment of the invention, the notification preferences may be defined by the user by calling a callback phone number included in the financial transaction notification message. The user may choose from among options provided by an Interactive Voice Response (IVR) system. The callback phone number may be associated with the specific financial transaction for which the financial transaction notification message was served to the user's mobile device. The notification preference may be retrieved by correlating the selected IVR options with properties of the financial transaction.

In accordance with another embodiment of the invention, the notification preferences may be defined by the user by selecting a Uniform Resource Locator (URL) specified in the financial transaction notification message and accessing a webpage which allows user definition of notification preferences.

In accordance with another embodiment of the invention, a mobile application may be provided and installed on the user's mobile device to display the financial transaction notification message and provide a user interface enabling the user to define notification preferences in the notification preference response message.

In accordance with another embodiment of the invention, a TNNP application includes a transaction notification module operable to serve financial transaction notification messages to the user's mobile device in accordance with notification filtering rules based on the user's notification preferences, a notification preference receiver module operable to receive a notification preference response message, and a notification preference processor module operable to process the notification preference response message to define at least one notification filtering rule based on the notification preference.

In accordance with another embodiment of the invention, a computer-implemented method for defining notification preferences using a financial transaction notification message served to a user on a mobile device and using properties of the financial transaction includes the steps of serving the financial transaction notification message, the financial transaction notification message being related to a financial transaction performed by the user, receiving a notification preference response message from the user, and defining at least one notification filtering rule based on the notification preference response message and the properties of the financial transaction.

In accordance with another embodiment of the invention, a system for defining notification preferences using a financial transaction notification message served to a user on a mobile device and using properties of the financial transaction includes a transaction notification module operable to serve the financial transaction notification message, the financial transaction notification message being related to a financial transaction performed by the user, a notification preference receiver module operable to receive a notification preference response message from the user, and a notification preference processor module operable to define at least one notification filtering rule based on the notification preference response message and the properties of the financial transaction.

There has been outlined, rather broadly, the more important features of the invention in order that the detailed description thereof that follows may be better understood, and in order that the present contribution to the art may be better appreciated. There are, of course, additional features of the invention that will be described below and which will form the subject matter of the claims appended herein.

In this respect, before explaining at least one embodiment of the invention in detail, it is to be understood that the invention is not limited in its application to the details of functional components and to the arrangements of these components set forth in the following description or illustrated in the drawings. The invention is capable of other embodiments and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates a block diagram of a transaction notification and notification preference process in accordance with the invention;

FIG. 2 illustrates a block diagram of a transaction notification and notification preference application in accordance with the invention;

FIG. 3 illustrates a block diagram of one embodiment of a transaction notification and notification preference system in a banking environment in accordance with the invention;

FIG. 4 illustrates a schematic representation of a notification filtering rule in accordance with the invention;

FIG. 5 illustrates a flow chart of a method of filtering financial transaction notification messages based on notification filtering rules in accordance with the invention;

FIG. 6 illustrates a flow chart of a method of preparing a notification preference response message in accordance with the invention;

FIG. 7 illustrates a flow chart of a method of processing the notification preference response message in accordance with the invention;

FIGS. 8-10 illustrate messages exchanged between the transaction notification and notification preference system and the user to define notification preferences in accordance with the invention; and

FIG. 11 illustrates a schematic representation of an instance of a notification filtering rule.

### DETAILED DESCRIPTION OF A PREFERRED EMBODIMENT OF THE INVENTION

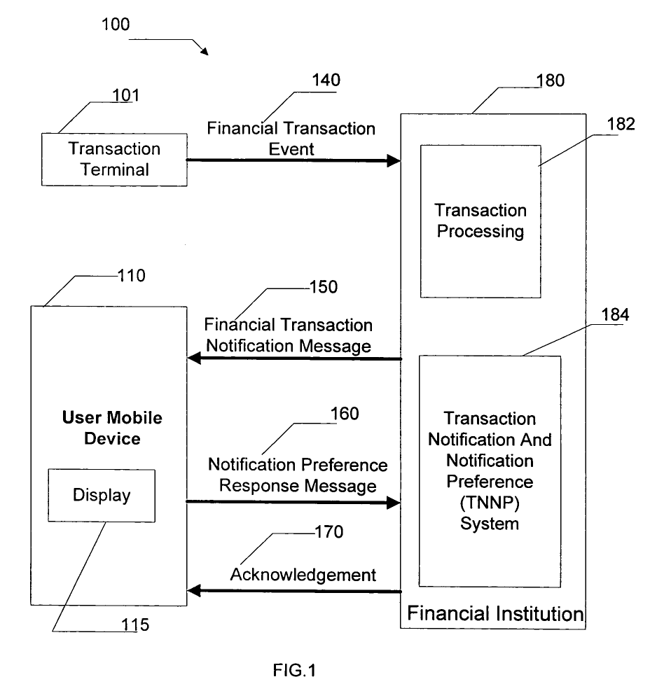

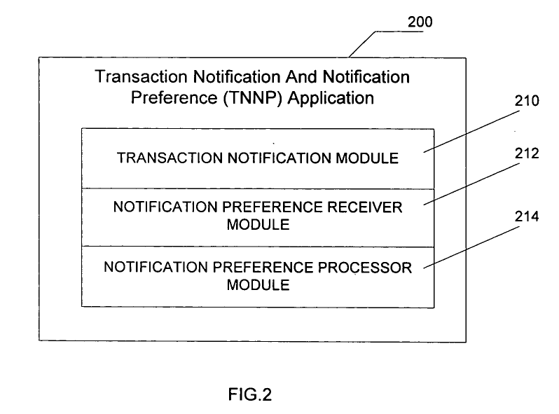

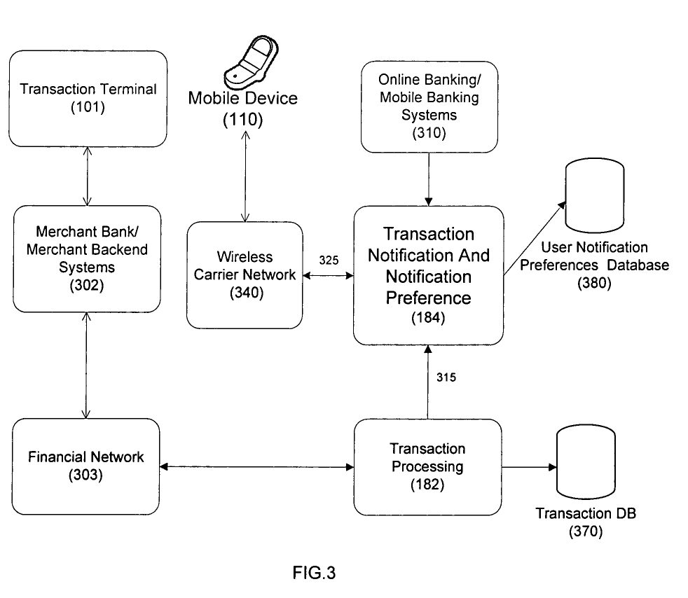

FIG. 1 illustrates a block diagram of the transaction notification and notification preference (TNNP) process generally designated 100 and will be described in combination with FIGS. 2-10. FIG. 2 illustrates a transaction notification and notification preference application 200 supporting the process 100. FIG. 3 shows an embodiment of a TNNP system in a banking environment.

FIG. 1 shows a transaction terminal 101 capable of processing a financial transaction performed by a user, a user mobile device 110 including a display 115, and a financial institution 180 including a transaction processing system 182 capable of processing financial transactions performed on the user's financial account and a transaction notification and notification preference (TNNP) system 184. In the art, the financial institution 180 is also referred to as a card issuing bank and may hold a financial account for the user and process financial transactions performed by the user. The systems 182 and 184 that are part of the financial institution 180 can be hosted by the financial institution or by third-parties.

The transaction terminal 101 may be any device capable of generating a financial transaction event requiring payment from the financial institution. A transaction terminal 101 at a point of transaction origin includes one of a debit/credit card reader which accepts ATM, debit and credit cards associated with banks and credit card companies such as Visa, Master Card, American Express and Discover. The transaction terminal 101 may include a check reader. The transaction terminal 101 may also include a payment system such as a NFC (near-field-communication) based payment system which can support payments made using contactless cards, mobile devices, and other devices. The transaction terminal 101 may also include a virtual terminal or an Internet payment gateway.

The process 100 comprises the following steps: 1) Financial institution 180 receives a financial transaction event 140 relating to a financial transaction performed by the user at the transaction terminal 101. Transaction event 140 is processed by the transaction processing system 182; 2) TNNP system 184 serves a financial transaction notification message 150 to the user on the user's mobile device 110 relating to the financial transaction event 140 and in accordance with notification filtering rules; 3) TNNP system 184 receives a notification preference response message 160 from the user's mobile device 110 in response to the financial transaction notification message 150 and defines notification filtering rules; and 4) TNNP system 184 optionally sends an acknowledgement message 170 to the user's mobile device 110.

The process 100 enables the user to easily define notification preferences in response to the financial transaction notification message. Advantageously, process 100 is an interactive process involving a 2-way communication including messages 150 and 160 between the TNNP system 184 and the user's mobile device 110. The financial transaction notification message 150 served to the user on the user's mobile device 110 provides a convenient way for a user to set notification preferences by responding to the financial transaction notification message.

The financial transaction event 140 is sent over a communication system (not shown). The communication system may include the Internet, an intranet, a cellular communication system, a wireless communication system, a wired communication system, a satellite communication system, and a cable communication system. The transaction event 140 may be communicated over one or more of a plurality of communication system and banking or financial system networks to the financial institution 180 associated with the user's financial account.

TNNP system 184 may include at least one processing unit and at least one memory unit implementing and storing a set of instructions for carrying out the TNNP process 100 and a TNNP application 200 (FIG. 2) as is well known in the art. The TNNP system 184 may also include interfaces for communicating via various communication networks.

FIG. 2 illustrates a block diagram of the TNNP application 200 implementing the TNNP process 100 (FIG. 1). The TNNP application 200 includes a transaction notification module 210, a notification preference receiver module 212, and a notification preference processor module 214.

TNNP application modules described herein can be hosted by the financial institution 180, by a third-party, or jointly wherein certain modules are hosted by the financial institution 180 and other modules are hosted by at least one third-party.

The transaction notification module 210 is operable to serve the financial transaction notification message 150 to the user's mobile device 110 relating to a financial transaction performed by the user. The transaction notification module 210 serves the financial transaction notification message 150 to the user's mobile device 110 based on notification filtering rules where notification filtering rules are applied to the properties of the financial transaction to determine whether the financial transaction notification message should be served to the user's mobile device 110. The notification filtering rules are defined by the notification preference processor module 214 by processing the notification preference response messages. Notification filtering rules are stored in a user notification preferences database 380 coupled to the TNNP system 184 (FIG. 3).

The transaction notification module 210 may serve the financial transaction notification message 150 using a messaging protocol including SMS, MMS, WAP Push, email, USSD, XMPP, SOAP, and HTTP. These protocols define how a message is delivered to the user's mobile device 110.

The notification preference receiver module 212 is operable to receive the notification preference response message 160 from the user in response to the financial transaction notification message. The notification preference response message 160 can be received by the notification preference receiver module 212 using messaging protocols including SMS, MMS, WAP Push, email, USSD, XMPP, SOAP, and HTTP. The notification preference receiver module 212 is further operable to receive the notification preference response message 160 through an IVR system.

The notification preference processor module 214 is operable to process the notification preference response message 160 received by the notification preference receiver module 212 to define at least one notification filtering rule based on the notification preference.

Users can set notification preferences based on options provided in the financial transaction notification message 150. In one embodiment of the invention, the financial transaction notification message 150 may include at least one action code corresponding to a notification preference corresponding to a property of the financial transaction. The notification preference response message 160 may include data including the at least one action code. The notification preference processor module 214 is operable to process the at least one action code to define the notification filtering rule.

In another embodiment of the invention, the user may indicate a notification preference by including a property of the financial transaction in the notification preference response message 160. The notification preference processor module 214 is operable to process the property of the financial transaction to define the notification filtering rule.

In yet another embodiment of the invention, the user may indicate a notification preference by replying with an empty notification preference response message 160. The notification preference processor module 214 is operable to process the empty notification preference response message 160 to provide a notification filtering rule.

In another embodiment of the invention, the notification preference may be defined by the user by calling a callback phone number included in the financial transaction notification message 150. The user may choose from among options provided by an Interactive Voice Response (IVR) system. The callback phone number is associated with the specific financial transaction for which the financial transaction notification message 150 was served to the user's mobile device 110. The notification preference may be retrieved by correlating the selected IVR options with properties of the financial transaction.

In another embodiment of the invention, the notification preference may be defined by the user by selecting a Uniform Resource Locator (URL) specified in the financial transaction notification message 150. The accessed webpage may provide an interface allowing user definition of notification preferences.

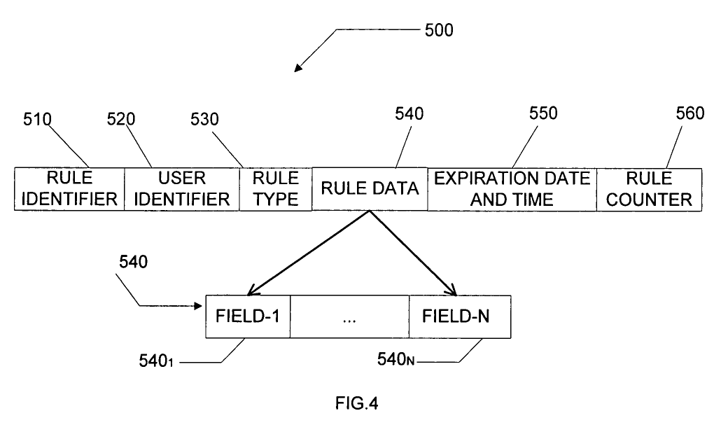

The notification preference response message 160 sent by the user may optionally include additional data related to the notification preference such as an expiration date and time as further described with reference to FIG. 4. The notification preference processor module 214 is operable to set the expiration date and time in the notification filtering rule.

The notification preference response message 160 sent by the user may further include additional data related to the notification preference such as a rule counter value as further described with reference to FIG. 4. The notification preference processor module 214 is operable to set the rule counter value in the notification filtering rule.

In another embodiment of the invention, a mobile application may be provided and installed on the user's mobile device 110 to display the financial transaction notification message 150 and provide a user interface enabling the user to define notification preferences in the notification preference response message 160.

The notification filtering rules defined by the notification preference processor module 214 include a notification filtering rule to exclude financial transaction notification messages for a financial transaction where the transaction location in the notification filtering rule is the same as the transaction location property of the financial transaction, a filtering rule to exclude financial transaction notification messages for financial transactions where the merchant name in the notification filtering rule is the same as the merchant name property of the financial transaction, a rule to exclude financial transaction notification messages for financial transactions where the transaction amount in the notification filtering rule is less than or equal to the transaction amount property of the financial transaction, a rule to exclude financial transaction notification messages for financial transactions where the merchant type in the notification filtering rule is the same as the merchant type property of the financial transaction, and combinations of properties of the financial transaction.

In another embodiment of the invention, the notification preferences are managed and applied to the financial transaction notification message 150 by a mobile application running on the user's mobile device 110. The mobile application filters the financial transaction notification message 150 received from the transaction notification module 210 based on notification filtering rules stored by the mobile application. The mobile application also provides the capability of setting notification preferences based on a financial transaction notification message 150 received by the mobile application. User selected notification preferences are stored on the mobile device by the mobile application.

FIG. 4 shows a schematic representation of a notification filtering rule generally designated 500 that may be stored in the user notification preferences database 380 (FIG. 3). The notification filtering rule 500 comprises a rule identifier 510 that uniquely identifies the notification filtering rule 500. A user identifier 520 uniquely identifies the user for which the notification filtering rule 500 is applicable. A rule type 530 indicates the type of the notification filtering rule 500. Rule types include a transaction location rule type, a merchant name rule type, a transaction amount less than or equal to rule type, a merchant type rule type, and combined transaction properties rule type such a merchant location rule type.

Notification filtering rule 500 further includes rule data 540. Rule data 540 may include one or more fields 540₁-540_{N} based on the rule type 530, representing filtering criteria. Each field 540₁-540_{N} holds a value of a financial transaction property that is compared with corresponding properties of the financial transaction in determining if the notification filtering rule is satisfied. For example, a notification filtering rule of type transaction location has a rule data field 540₁-540_{N} that holds a value for the location. This value is used by the TNNP system 184 in determining if the notification filtering rule applies to a financial transaction performed by the user. If the value in the rule data field matches the transaction location property of the financial transaction, the financial transaction notification message 150 is not served to the user's mobile device 110; otherwise the financial transaction notification message 150 is served to the user's mobile device 110.

Expiration date and time 550 indicate the date and time after which the notification filtering rule 500 expires. The expiration date and time may be provided in the notification preference response message 160 as a user preference. Alternatively, the expiration date and time may be system dependant.

The notification filtering rule 500 may also comprise a rule counter 560 that causes the notification filtering rule 500 to expire after a specified number of times in which the filtering criteria for the notification filtering rule 500 are met. The value of the rule counter may be provided in the notification preference response message 160 as a user preference. Alternatively, the value of the rule counter may be system dependent.

To define the notification filtering rule 500, the notification preference processor module 214 (FIG. 2) determines the rule type 530 from the notification filtering response message 160. The notification filtering response message 160 may include an action code indicating the rule type 530. Rule data 540 may also be explicitly included in the notification filtering response message 160 or alternatively the rule data 540 may be extracted from the properties associated with the financial transaction for which the financial transaction notification message 150 was served to the user's mobile device 110.

FIG. 3 illustrates a block diagram of the TNNP system 184 in a banking environment in accordance with one aspect of the invention. The TNNP system 184 and the user notification preferences database 380 integrate with other banking systems including a transaction processing system 182, online/mobile banking systems 310, and a transaction database 370. The TNNP system 184 and various banking systems may be hosted by various parties. In one embodiment the TNNP system 184 includes the modules of the TNNP application 200 and other banking system modules may be hosted by the bank. In another embodiment the TNNP system 184 includes modules of the TNNP application 200 and may be hosted by one or more third-party service providers where banking system modules may be hosted by the bank or other third-party service providers.

The transaction processing system (TPS) 182 is responsible for processing financial transactions on the user's financial account upon receiving the financial transaction event 140 (FIG. 1). The transaction processing system 182 receives financial transaction events from a financial network 303. Financial network 303 integrates with the merchant bank or the backend systems 302 to process a financial transaction performed by a user at a transaction terminal 101. However, it is also possible that the system 182 may receive financial transaction events directly from a merchant bank or merchant backend system 302 or other systems which may be involved in financial transaction processing.

The TPS 182 sends the financial transaction event 140 to the TNNP system 184 using an application programming interface (API) 315 provided by the TNNP application 200 running on the TNNP system 184. The TNNP application 200 modules may be physically deployed on multiple physical servers.

The TNNP system 184 is operable to serve financial transaction notification messages 150 to the user's mobile device 110. The TNNP system 184 integrates with a wireless carrier network 340 using various Application Programming Interfaces (API) provided by wireless operators 325. These APIs may be different for different wireless operators. In an alternative configuration, the TNNP system 184 may interface with an SMS Aggregator that integrates with the wireless operators 325. This may be done for various business or technical reasons which force the financial transaction notification messages to be delivered through an SMS aggregator.

The TNNP system 184 is operable to send financial transaction notification messages 150 using messaging protocols supported by the wireless carrier network 340 and the user's mobile device 110. Supported messaging protocols include SMS, MMS, WAP Push, USSD, SOAP, HTTP, and XMPP. It is also operable to support a trigger based mechanism of delivering the financial transaction notification messages. In the trigger based method, the TNNP system 184 first sends a trigger message to the user's mobile device 110. This trigger message acts as a trigger to a mobile application running on the mobile device 110 to fetch the financial transaction notification message 150.

The TNNP system 184 may also integrate with other systems, instead of directly connecting with the wireless carrier 340, for delivering financial transaction notification messages. For example, sending an email to the user's mobile device 110 may not require a direct integration between the TNNP system 184 and the wireless carrier 340. The TNNP system 184 may integrate with an email server which delivers an email to the user's mobile device 110 using technology such as Blackberry.

Mobile device 110 receives the financial transaction notification message 150 relating to the financial transaction performed by the user. The user can define notification preferences by responding to the financial transaction notification message from the user's mobile device 110. The notification preference response message 160 is delivered to the TNNP system 184 through the wireless carrier network 340.

Online/Mobile banking systems 310 provide a graphical user interface (GUI) to the user for use in various banking services. These systems may support managing notification preferences.

Online/Mobile banking system 310 may also be enhanced to support setting notification preferences based on the user's past transaction history and using properties of a financial transaction such as the merchant name, the transaction location, the merchant type, the merchant name, and the transaction type. In one implementation a user may be shown, using a graphical user interface, a list of merchants that the user has performed transactions with in the past and the user can then set a notification preference to filter transactions performed at one or more merchants by selecting the merchant names. A notification preference to filter transactions based on the transaction location can be set by showing the user a list of merchants and for each merchant the list of locations where the user has performed transactions in the past. The user can then select one or more locations to create the transaction location based notification filtering rule.

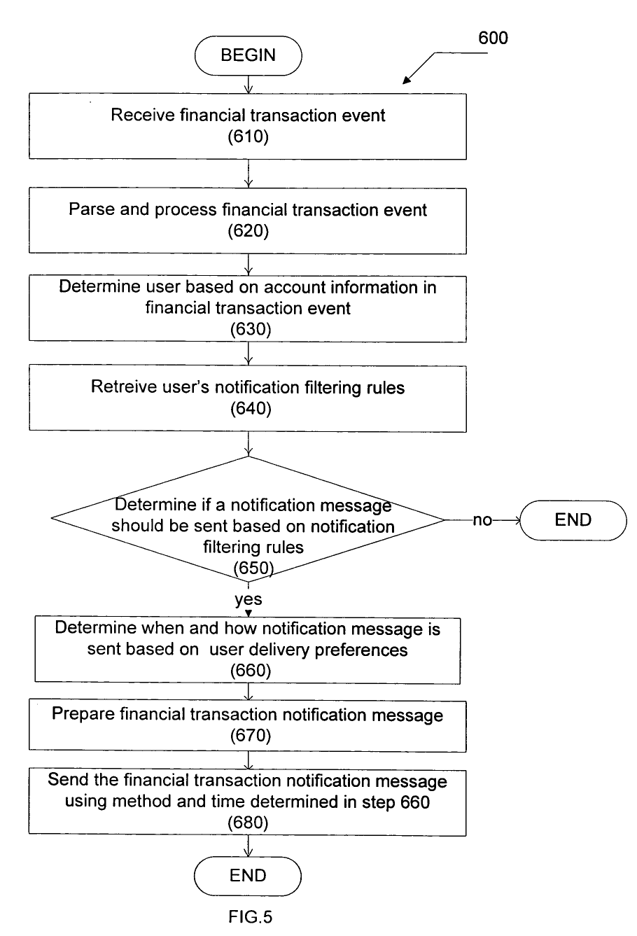

FIGS. 5-7 illustrate steps of the TNNP process 100 (FIG. 1). In various configurations below, steps are performed in the depicted order or the steps or portions thereof may be performed contemporaneously, in parallel, or in a different order.

With reference to FIG. 5, a process generally designated 600 begins with step 610 in which the TNNP system 184 (FIG. 1) receives a transaction event 140. In step 620 the received transaction event 140 is parsed and processed. The user is determined in step 630 based on the account information in the transaction event 140. In step 640 the notification filtering rules for the user are retrieved from the user notification preferences database 380 and in step 650 the notification filtering rules that have not expired and that don't have a rule count of zero are applied to properties of the financial transaction to determine if a financial transaction notification message 150 should be sent to the user. If the determination is “NO,” the process ends. If the determination is “YES”, then in step 660 a determination is made on how and when the financial transaction notification message 150 should be delivered to the user's mobile device 110. In step 670 a financial transaction notification message 150 is prepared. The financial transaction notification message 150 may include some or all of the financial transaction properties. The financial transaction notification message 150 may additionally include at least one action code for setting notification filtering rules using the notification preference response message 160. In step 680 the financial transaction notification message 150 is scheduled for delivery at the time determined in step 660 and using the method determined in step 660. The steps in FIG. 5 are associated with tasks related to TNNP system 184.

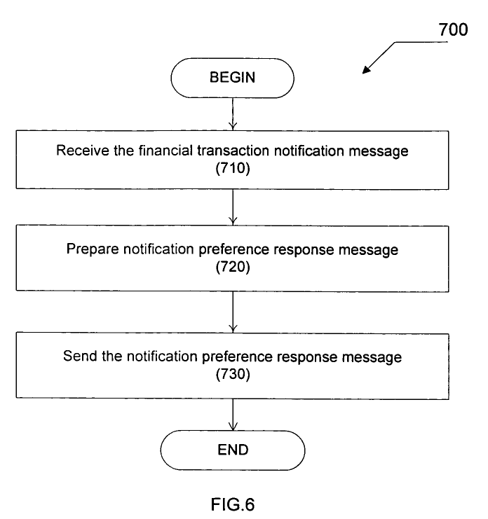

With reference to FIG. 6, the steps are associated with end-user tasks on the mobile device 110. A method generally designated 700 includes step 710 in which the user receives the financial transaction notification message 150. The user prepares the notification preference response message 160 using action codes in the financial transaction notification message 150 or by using a mobile application in step 720. In step 730 the notification preference response message 160 is sent to the TNNP system 184.

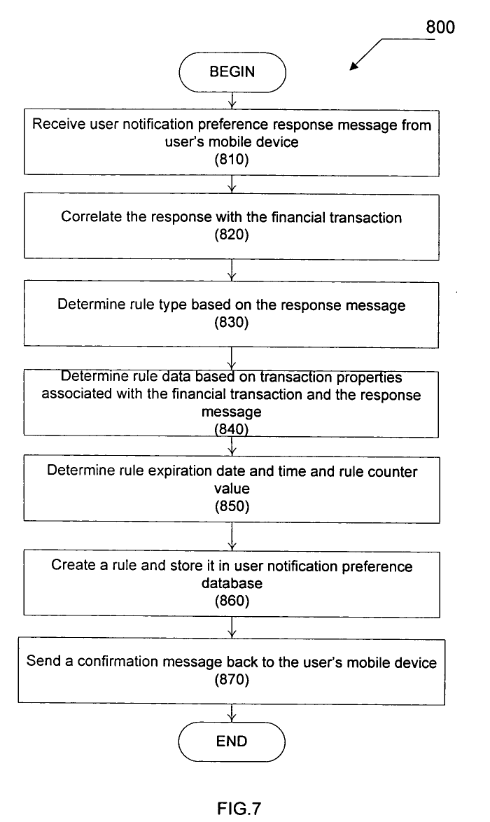

With reference to FIG. 7, the steps in a method generally designated 800 are associated with system tasks performed by the TNNP system 184. In step 810, the TNNP system 184 receives the notification preference response message 160. The notification preference response message 160 is correlated to the financial transaction in step 820 based on an identifier found in the notification preference response message 160 or based on the address where the notification preference response message 160 is received. In step 830 a rule type for the notification preference is determined from the notification preference response message 160. Rule data 540 for the rule 500 is determined from the properties associated with the financial transaction and the notification preference response message 160 in step 840. In step 850 the expiration date and time for the notification filtering rule 500 and the value of the rule counter for the notification filtering rule 500 are determined. The expiration date and time can be explicitly provided by the user in the notification preference response message 160 or a default value may be specified by the system. The value of the rule counter can be explicitly provided by the user in the notification preference response message 160 or a default value may be specified by the system. In step 860 a notification filtering rule is created and stored in the user notification preferences database 380. A confirmation message is sent to the user on the user's mobile device 110 in step 870.

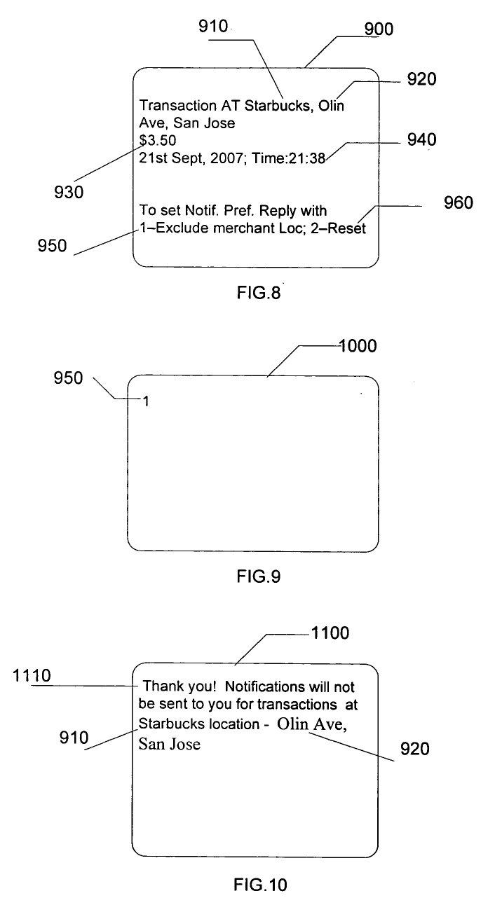

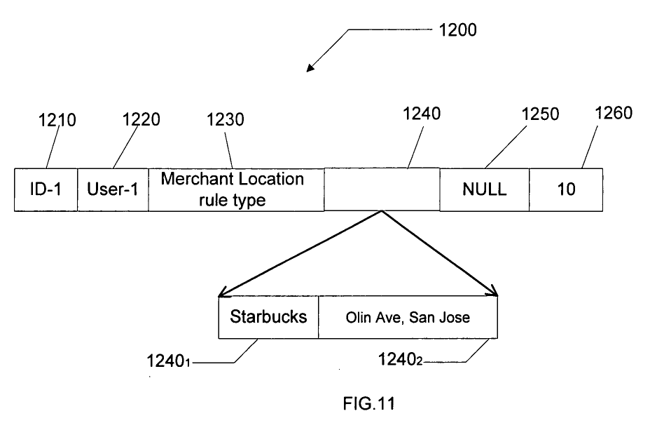

FIGS. 8-10 show exemplary messages exchanged between the user's mobile device 110 and the TNNP system 184 (FIG. 1) to support the TNNP process 100 (FIG. 1). The messages result in a notification filtering rule generally designated 1200 shown in FIG. 11 which is an exemplary instance of notification filtering rule 500.

FIG. 8 illustrates a financial transaction notification message 900. The financial transaction notification message 900 is intended to be displayed on a display 115 (FIG. 1) of a user's mobile device 110. The financial transaction notification message 900 includes properties of the financial transaction based on the financial transaction event 140. The financial transaction notification message 900 includes a merchant (vendor) name field 910, a merchant store location 920, a transaction date and time field 940, and the dollar amount field 930.

The financial transaction notification message 900 includes action codes 950 and 960. Inclusion of the action code 950 in a notification preference response message 1000 indicates a notification preference to filter financial transaction notification messages related to financial transactions performed at the merchant location. The merchant location is defined by a combination of the merchant name and transaction location. Inclusion of the action code 960 in the notification preference response message 1000 indicates a notification preference to reset all previously defined notification filtering rules.

FIG. 9 illustrates a notification preference response message 1000. The message 1000 includes the action code 950. The action code 950 is processed by the notification preference processor module 214 to define the notification filtering rule 1200 (FIG. 11).

FIG. 10 illustrates a notification preference acknowledgement message 1100. The notification preference acknowledgement message 1100 provides the user with an indication that the notification preference has been set.

With reference to FIG. 11, the notification filtering rule 1200 comprises a rule identifier 1210 having a value of ID-1, a user identifier 1220 having a value of User-1, a rule type 1230 having a value of Merchant Location rule type, a rule data 1240 having fields 1240₁ having a value of Starbucks (corresponding to the merchant name) and 1240₂ having a value of Olin Ave, San Jose (corresponding to the transaction location), a rule expiration date and time 1250 having a NULL value, and a rule counter 1260 having a value of 10. TNNP system 184 is operable to apply the notification filtering rule 1200 to financial transactions performed by the User-1 in determining whether or not to serve a financial transaction notification message 150 to the user's mobile device 110. With these notification preferences, the next ten financial transactions performed by User-1 at the Starbucks located at Olin Ave. in San Jose will not result in financial transaction notification messages being served to the user's mobile device 110.

In one or more exemplary configurations, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The method and system for defining user financial transaction notification preferences in accordance with the invention provide a means by which a user may define notification preferences based on properties of a financial transaction performed by the user. The method and system also provide an interactive means by which the user may define notification preferences in response to financial transaction notification messages. The method and system further provide a means by which the financial transaction notification message provides a context for the user to define notification preferences, the financial transaction notification message including properties of the financial transaction.

The previous description of the disclosed methods and systems is provided to enable a person skilled in the art to make and use the invention. Various modifications to these methods and systems will be readily apparent to those skilled in the art, and the principles defined herein may be applied to other methods and systems without departing from the spirit or scope of the disclosure. For example, while financial transaction notification messages may be used for purposes of fraud detection, other purposes are within the scope of the invention. Thus, the disclosure is not intended to be limited to the methods and systems shown herein but is to be accorded the widest scope consistent with the principles and novel features disclosed herein.

What is claimed is:

1. A computer-implemented method for defining notification preferences using a financial transaction notification message served to a user on a mobile device and using properties of the financial transaction comprising the steps of:
serving the financial transaction notification message, the financial transaction notification message being related to a financial transaction performed by the user;
receiving a notification preference response message from the user; and
defining at least one notification filtering rule based on the notification preference response message and the properties of the financial transaction.

2. The computer-implemented method of claim 1, wherein defining the at least one notification filtering rule comprises determining a rule type and rule data.

3. The computer-implemented method of claim 2, wherein determining the rule type comprises processing data included in the notification preference response message.

4. The computer-implemented method of claim 3, wherein the data comprises an action code.

5. The computer-implemented method of claim 2, wherein determining the rule data comprises extracting data from the properties of the financial transaction.

6. The computer-implemented method of claim 2, wherein determining the rule data comprises extracting data from the properties of the financial transaction and the notification preference response message.

7. The computer-implemented method of claim 1, wherein defining the at least one notification filtering rule based on the transaction notification preference response message and properties of the financial transaction comprises determining an expiration date and time for the notification filtering rule.

8. The computer-implemented method of claim 1, wherein defining the at least one notification filtering rule based on the notification preference response message and the properties of the financial transaction comprises determining a rule counter value for the notification filtering rule.

9. The computer-implemented method of claim 1, wherein receiving a notification preference response message from the user comprises receiving an output of an interactive voice response system in response to the user interaction with the interactive voice response system, wherein a callback phone number for the interactive voice response system is provided in the financial transaction notification message.

10. The computer-implemented method of claim 1, wherein receiving a notification preference response message from the user comprises receiving the notification preference response message through a web interface, wherein a Uniform Resource Locator of the web interface is provided in the financial transaction notification message.

11. A system for defining notification preferences using a financial transaction notification message served to a user on a mobile device and using properties of the financial transaction comprising:
a transaction notification module operable to serve the financial transaction notification message, the financial transaction notification message being related to a financial transaction performed by the user;
a notification preference receiver module operable to receive a notification preference response message from the user; and
a notification preference processor module operable to define at least one notification filtering rule based on the notification preference response message and the properties of the financial transaction.

12. The system of claim 11, wherein the notification preference processor module is further operable to determine a rule type and rule data for the at least one notification filtering rule.

13. The system of claim 12, wherein the notification preference processor module is further operable to determine the rule type by processing data included in the notification preference response message.

14. The system of claim 13, wherein the data included in the notification preference response message comprises an action code.

15. The system of claim 12, wherein the notification preference processor module is further operable to determine the rule data by extracting data from properties of the financial transaction.

16. The system of claim 11, wherein the notification preference processor module is further operable to determine the rule data by extracting data from the properties of the financial transaction and the notification preference response message.

17. The system of claim 11, wherein the notification preference processor module is further operable to determine an expiration date and time for the notification filtering rule.

18. The system of claim 11, wherein the notification preference processor module is further operable to determine a rule counter value for the notification filtering rule.

19. The system of claim 11, wherein the notification preference receiver module is further operable to receive the notification preference response message as an output of an interactive voice response system in response to the user interaction with the interactive voice response system, wherein a callback phone number for the interactive voice response system is provided in the financial transaction notification message.

20. The system of claim 11, wherein the notification preference receiver module is further operable to receive the notification preference response message through a web interface, wherein a Uniform Resource Locator of the web interface is provided in the financial transaction notification message.
